(19) United States
(12) Patent Application Publication
(10) Pub. No.: US 2021/0109637 A1
(43) Pub. Date: Apr. 15, 2021

(54) TOUCH PANEL CONTROLLER FOR NON-LIGHT-EMITTING VARIABLE TRANSMISSION DEVICES AND A METHOD OF USING THE SAME

(71) Applicant: SAGE ELECTROCHROMICS, INC., Faribault, MN (US)

(72) Inventors: Troy LIEBL, Owatonna, MN (US); David BUSZMANN, New Market, MN (US); Cody VanDerVeen, Faribault, MN (US); Leo SU, Lakeville, MN (US)

(21) Appl. No.: 17/067,168

(22) Filed: Oct. 9, 2020

Related U.S. Application Data
(60) Provisional application No. 62/915,147, filed on Oct. 15, 2019.

(51) Int. Cl. G06F 3/041; G02F 1/163; G02F 1/155; G02F 1/1523; G02F 1/1516

(52) U.S. Cl. CPC G06F 3/04164; G02F 1/163; G02F 1/155; G02F 2202/16; G02F 1/15165; G02F 2001/1552; G02F 1/1523

(57) ABSTRACT

A control system for controlling electrochromic devices can include one or more non-light emitting, variable transmission devices and a control management device, where the control management device includes a touch-panel platform and a logic element configured to map one or more operational parameters of the one or more non-light emitting, variable transmission devices, integrate the mapped one or more operational parameters into the touch panel platform, and send one or more signals to the one or more non-light emitting, variable transmission devices in response to input received from the touch panel control platform.

### CROSS-REFERENCE TO RELATED APPLICATION(S)

This application claims priority under 35 U.S.C § 119(e) to U.S. Provisional Application No. 62/915,147, entitled “TOUCH PANEL CONTROLLER FOR NON-LIGHT-EMITTING VARIABLE TRANSMISSION DEVICES AND A METHOD OF USING THE SAME,” by Troy LIEBL et al., filed Oct. 15, 2019, which is assigned to the current assignee hereof and is incorporated herein by reference in its entirety.

### FIELD OF THE DISCLOSURE

The present disclosure is directed to systems that include non-light-emitting variable transmission devices, and more specifically to a touch panel controller and system for non-light-emitting variable transmission devices and methods of using the same.

### BACKGROUND

A non-light-emitting variable transmission device can reduce glare and the amount of sunlight entering a room. Buildings can include many non-light-emitting variable transmission devices that may be controlled locally (at each individual or a relatively small set of devices), for a room, or for a building (a relatively large set of devices). Wiring the devices can be very time consuming and complicated, particularly as the number of devices being controlled increases. Connecting the devices to their corresponding control system can be performed on a wire-by-wire basis using electrical connectors or connecting techniques, such as terminal strips, splicing, soldering, wire nuts, or the like.

However, as the capabilities of non-light-emitting variable transmission devices advance so too do the demands for control strategies that are able to meet those needs. As such, a need exists for a better control strategy regarding non-light-emitting variable transmission devices.

### BRIEF DESCRIPTION OF THE DRAWINGS

Embodiments are illustrated by way of example and are not limited in the accompanying figures.

FIG. 1 includes a schematic depiction of a system for controlling a set of non-light-emitting, variable transmission devices in accordance with an embodiment.

FIG. 2 includes a flow diagram for operating the system of FIG. 1.

FIG. 3A includes an illustration of a top view of the substrate, the stack of layers, and the bus bars.

FIG. 3B includes an illustration of a cross-sectional view along line A of a portion of a substrate, a stack of layers for an electrochromic device, and bus bars, according to one embodiment.

FIG. 3C includes an illustration of a cross-sectional view along line B of a portion of a substrate, a stack of layers for an electrochromic device, and bus bars, according to one embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

A system can include a non-light-emitting, variable transmission device, a control management system configured to send signals to the one or more non-light-emitting, variable transmission device after receiving input from a touch-panel platform.

The systems and methods are better understood after reading the specification in conjunction with the figures. System architectures are described and illustrated, followed by an exemplary construction of a non-light-emitting, variable transmission device, and a method of controlling the system. The embodiments described are illustrative and not meant to limit the scope of the present invention, as defined by the appended claims.

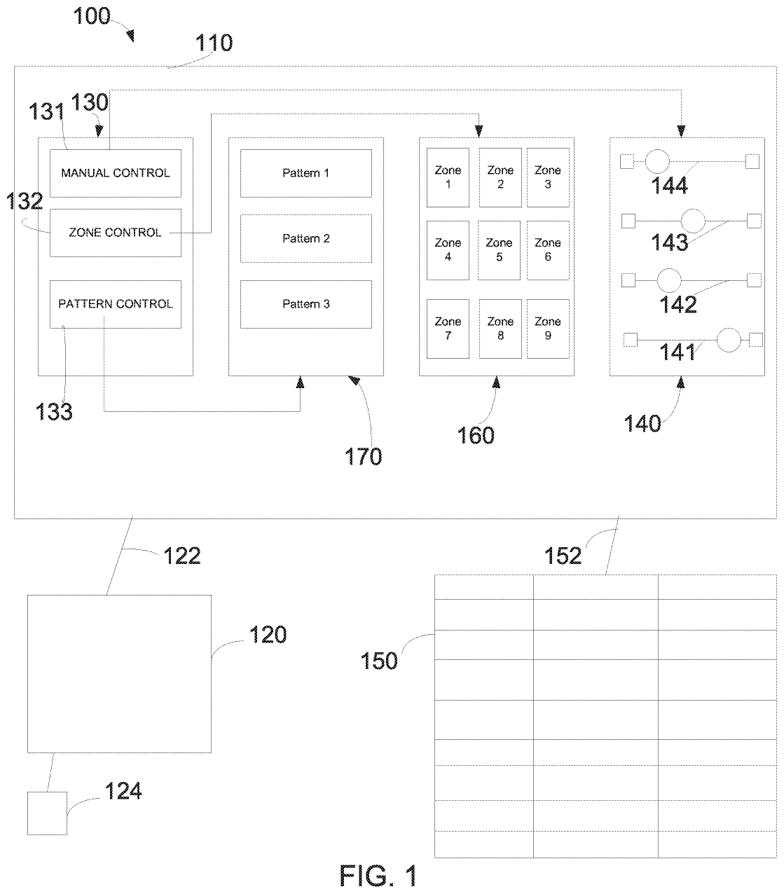

Referring to FIG. 1, a system for controlling a set of non-light-emitting, variable transmission devices is illustrated and is generally designated 100. As depicted, the system 100 can include a control management system 110. In a particular aspect, the control management system 110 can include a graphical interface such as an analog and digital interface. In one embodiment, the graphical interface can be a touch-panel control platform with multiple drop down menus and screens. The control management system 110 can be used to control the heating ventilation air condition (HVAC) system of the building, interior lighting, exterior lighting, emergency lighting, fire suppression equipment, elevators, escalators, alarms, security cameras, access doors, another suitable component or sub-system of the building, non-light emitting, variable transmission device, or any combination thereof.

The control management system 110 can be connected to a router 120 via a control link 122. The control link 122 can be a wireless connection. In an embodiment, the control link 122 can use a wireless local area network connection operating according to one or more of the standards within the IEEE 802.11 (Wi-Fi) family of standards. In a particular aspect, the wireless connections can operate within the 2.4 GHz ISM radio band, within the 5.0 GHz ISM radio band, or a combination thereof.

Regardless of the type of control link 122, the control management system 110 can receive power and control signals from the router 120 via the control link 122. The control signals can be used to control the operation of one or more non-light-emitting variable transmission devices that are indirectly, or directly, connected to the router 120 and described in detail below. As indicated in FIG. 1, the router 120 can be connected to an alternating current (AC) power source 124. The router 120 can include an onboard AC-to-direct current (DC) converter 210. The onboard AC-to-DC converter can convert the incoming AC power from the AC power source 124, approximately between 100 and 240 Volts (V) AC, to a DC voltage that is at most 60 VDC, 54 VDC, 48 VDC, 24 VDC, at most 12 VDC, at most 6 VDC, or at most 3 VDC. The onboard AC-to-DC converter can have an universal input of between 50 and 60 Hz. The router 120 can include a plurality of connectors. The onboard AC-to-DC converter within the router 120 can be coupled to the power input port of the router 120. In a particular aspect, the connectors (not shown) can include one or more RJ-11 jacks, one or more RJ-14 jacks, one or more RJ-25 jacks, one or more RJ-45 jacks, one or more 8P8C jacks, another suitable jack, or a combination thereof. In another aspect, the connectors can include one or more universal serial bus (USB) jacks.

Still referring to FIG. 1, the system 100 can also include a window frame panel 150 electrically connected to the control management system 110 via a plurality of sets of frame cables 152. The window frame panel 150 can include a plurality of non-light-emitting, variable transmission devices, each of which may be connected to its corresponding controller via its own frame cable. In the embodiment as illustrated, the non-light-emitting, variable transmission devices are oriented in a 3×9 matrix. In another embodiment, a different number of non-light-emitting, variable transmission devices, a different matrix of the non-light-emitting, variable transmission devices, or both may be used. Each of the non-light-emitting, variable transmission devices may be on separate glazings. In another embodiment, a plurality of non-light-emitting, variable transmission devices can share a glazing. For example, a glazing may correspond to a column of non-light-emitting, variable transmission devices in FIG. 1. A glazing may correspond to a plurality of column of non-light-emitting, variable transmission devices. In another embodiment, a pair of glazings in the window frame panel 150 can have different sizes, such glazings can have a different numbers of non-light-emitting, variable transmission devices. After reading this specification, skilled artisans will be able to determine a particular number and organization of non-light-emitting, variable transmission devices for a particular application.

The control management system 110 can provide regulated power to the non-light-emitting, variable transmission devices connected thereto via the sets of frame cables 152. In a particular aspect, the control management system 110 can be connected to a non-light-emitting, variable transmission devices controller that provides the voltage to the non-light-emitting, variable transmission devices. The power provided to the non-light-emitting, variable transmission devices can have a voltage that is at most 12 V, at most 6 V, or at most 3 V. The control management system 110 can be used to control operation of the non-light-emitting, variable transmission devices. During operation, the non-light-emitting, variable transmission devices act similar to capacitors. Thus, most of the power is consumed when the non-light-emitting, variable transmission devices are in their switching states, not in their static states.

The control management system 110 can provide control signals used to control the operation of one or more non-light-emitting variable transmission devices. The control management system 110 can include a first panel 130. The first panel 130 can include an plurality of modules. As seen in FIG. 1, the first panel 130 can include three modules 131, 132, 133. In another embodiment, the first panel 130 can include at least 2 modules, such as at least 3 modules, or at least 4 modules, at least 10 modules, or at least 20 modules. In one embodiment, the first panel 130 can include at most 50 modules, such as at most 40 modules, or at least 30 modules. Each module can control a different operation of the non-light-emitting, variable transmission devices. For example, module 131 can include manual operation of the non-light-emitting, variable transmission devices and can be connected to a second panel 140. Within the second panel 140, a user could manually adjust various modules, such as tint level 141, grading pattern 142, glare control 143, and holding time 144 of the non-light-emitting, variable transmission devices by moving a bar from left to right or right to left. In one embodiment, the modules can also display the status of the non-light-emitting, variable transmission devices. For example, prior to adjustment, the module can display the transmittance of each non-light-emitting, variable transmission device. Module 132 can include zone control of the non-light-emitting, variable transmission devices and can be connected to a third panel 160. Zone control can include operations for controlling one or more zones independently. Module 133 can include pattern control of the non-light-emitting, variable transmission devices and can be connected to a fourth panel 170. Pattern control can include one or more set patterns that a user can select. After the collection of scenes is generated, a scene from the collection can be selected, and a control device can control the EC devices of the window to achieve scene for the window.

The operations noted can incorporate algorithms for 3-D models of a building and surrounding structures, shadow information, reflectance information, lighting and radiation information, information regarding one or more variable characteristics of glass, log information related to manual overrides, occupant preference information, motion information, real-time sky conditions, solar radiation on a building, a total foot-candle load on a structure, brightness overrides, time-of-year information, and microclimate analysis.

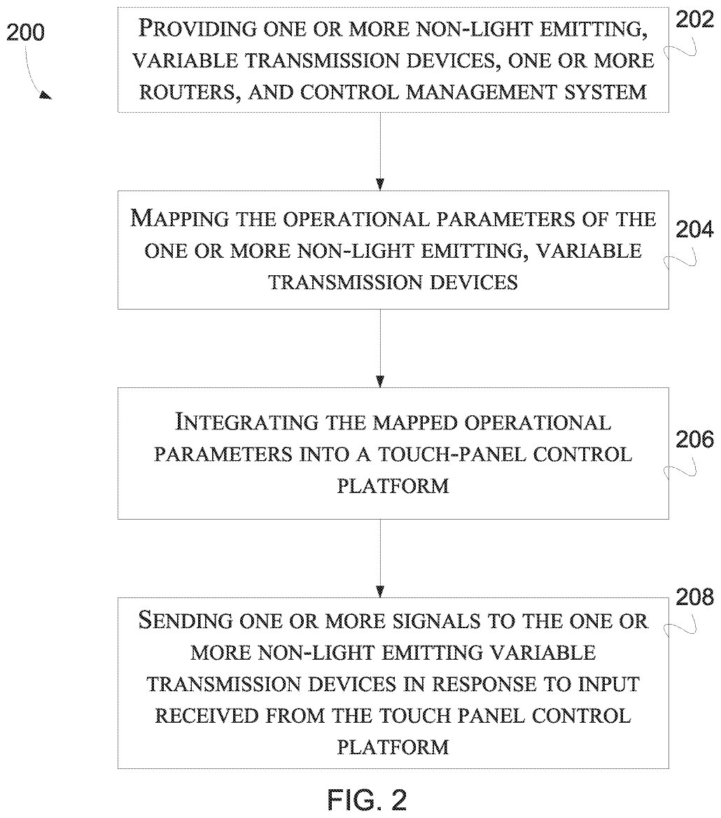

The method of operation is described in greater detail below in conjunction with FIG. 2. With respect to a configuration, the system 100 can include a logic element, e.g., within the control management system 110 that can perform the method steps described below. In particular, the logic element can be configured to send commands to control the various non-light emitting, variable transmission devices. For example, the controller can regulate the voltage being transmitted to the non-light-emitting, variable transmission devices in response to a tint or clear command.

The system can be used with a wide variety of different types of non-light-emitting variable transmission devices. The apparatuses and methods can be implemented with switchable devices that affect the transmission of light through a window. Much of the description below addresses embodiments in which the switchable devices are electrochromic devices. In other embodiments, the switchable devices can include suspended particle devices, liquid crystal devices that can include dichroic dye technology, and the like. Thus, the concepts as described herein can be extended to a variety of switchable devices used with windows.

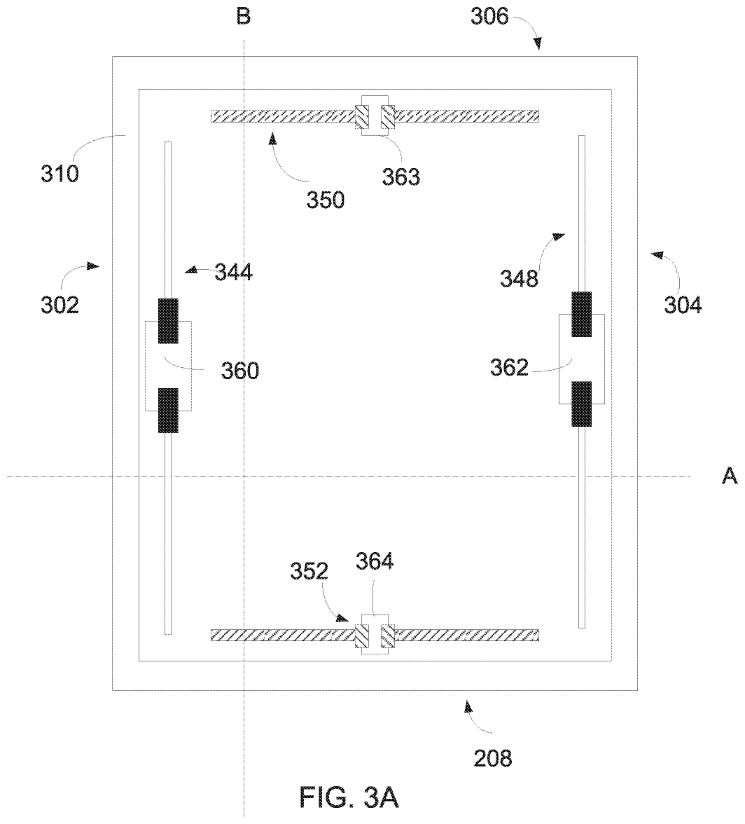

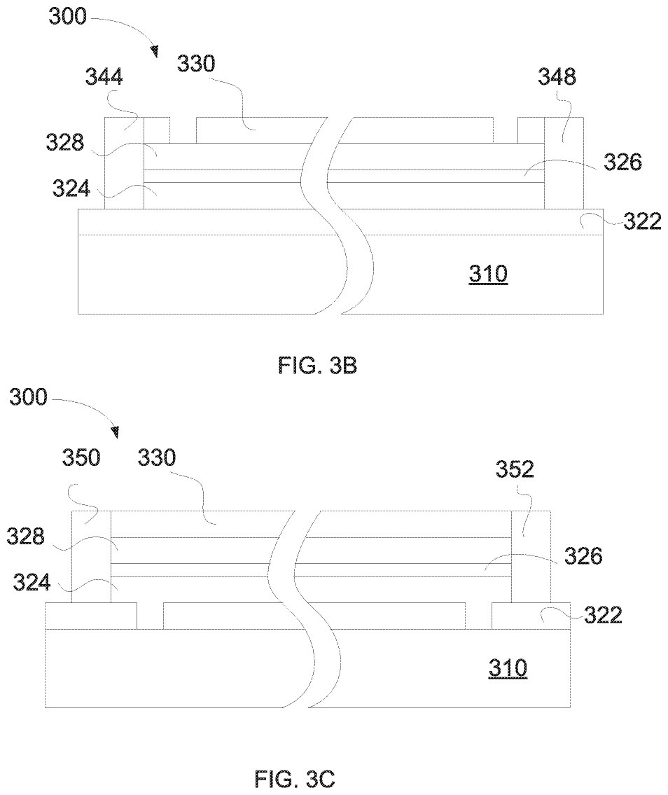

The description with respect to FIGS. 3A-3C provide exemplary embodiments of a glazing that includes a glass substrate and a non-light-emitting variable transmission device disposed thereon. The embodiment as described with respect to 3A-3C is not meant to limit the scope of the concepts as described herein. In the description below, a non-light-emitting variable transmission device will be described as operating with voltages on bus bars being in a range of 0V to 3V. Such description is used to simplify concepts as described herein. Other voltage may be used with the non-light-emitting variable transmission device or if the composition or thicknesses of layers within an electrochromic stack are changed. The voltages on bus bars may both be positive (1V to 4V), both negative (−5V to −2V), or a combination of negative and positive voltages (−1V to 2V), as the voltage difference between bus bars are more important than the actual voltages. Furthermore, the voltage difference between the bus bars may be less than or greater than 3 V. After reading this specification, skilled artisans will be able to determine voltage differences for different operating modes to meet the needs or desires for a particular application. The embodiments are exemplary and not intended to limit the scope of the appended claims.

FIG. 2 includes flow chart for a method 200 of operating the system 100 illustrated in FIG. 1. Commencing at block 202, the method can include providing one or more non-light-emitting, variable transmission devices, one or more routers, and a control management system coupled to the one or more glazings and the one or more routers. In an embodiment, the non-light-emitting, variable transmission devices, routers, and controllers may be connected to each other as illustrated in FIG. 1 and use non-light-emitting variable transmission devices similar to the non-light-emitting variable transmission device described and illustrated in FIGS. 3A-3B.

The control management system 110 can include logic to control the operation of building environmental and facility controls, such as heating, ventilation, and air conditioning (HVAC), lights, scenes for EC devices, including the EC device 300. The logic for the control management system 110 can be in the form of hardware, software, or firmware. In an embodiment, the logic may be stored in a field programmable gate array (FPGA), an application-specific integrated circuit (ASIC), a hard drive, a solid state drive, or another persistent memory. In an embodiment, the control management system 110 may include a processor that can execute instructions stored in memory within the control management system 110 or received from an external source.

Continuing the description of the method 200, at block 204, the method can include mapping the one or more non-light emitting, variable transmission devices. In one embodiment, mapping the one or more non-light emitting, variable transmission devices can include receiving information from 3-D models of a building and surrounding structures, pre-programmed scenes, shadow information, reflectance information, lighting and radiation information, information regarding one or more variable characteristics of glass, log information related to manual overrides, occupant preference information, motion information, real-time sky conditions, solar radiation on a building, a total foot-candle load on a structure, brightness overrides, time-of-year information, commissioning information such as dimensions of each non-light emitting, variable transmission device, and microclimate analysis. Mapping can include categorizing the above information and incorporating the information within the control management system 110.

After mapping the one or more non-light emitting, variable transmission devices, the control management system 110 can integrate the mapped information into a touch-panel control platform, such as into modules 130, 140, 160, and 170. In one example, integrating the mapped information into a touch-panel control platform can include storing the information within modules 130, 140, 160, and 170. In one embodiment, the touch-panel control platform can display the status of each non-light emitting, variable transmission device. In one embodiment, the status can include tint status, clearing status, holding status, etc. For example, module 140 can display the tint status prior to any additional input, during a first signal, and after the first signal has been received.

The control management system 110 can receive input from the modules 130, 140, 160, and 170. At operation 208, control management system 110 can send one or more signals to the one or more non-light emitting, variable transmission devices in response to input received from the touch panel control platform. In one embodiment, the input can be from a single module in which the control management system 110 would send a signal to one or more non-light emitting, variable transmission devices to regulate the power, transmittance, voltage, or any combination thereof of said device/devices. In another embodiment, the input can be from more than one module in which the control management system 110 would send a signal to one or more non-light emitting, variable transmission devices to regulate the power, transmittance, voltage, or any combination thereof of said device/devices.

The control management system can be electrically connected to a non-light-emitting, variable transmission device controller through a supervisor (not shown). In one embodiment, the touch panel control platform can send commands to the supervisor, the supervisor processes the received commands, and sends commands to the non-light-emitting, variable transmission device controller. In such a system, the window control then provides the voltage to the one or more non-light-emitting, variable transmission devices. Before sending the signal from the one or more modules, the control management system 110 could prioritize the input received into a hierarchy related to operations of the one or more non-light emitting, variable transmission devices. For example, to alter the transmittance from full clear to full tint may require a voltage change of 5V, where to alter the pattern may only require a voltage change of 3V. As such the control management system 110 could prioritize the input received to first alter the transmittance and then alter the pattern thus supplying varying voltages to different portions of the one or more non-light emitting, variable transmission devices. In one embodiment, a supervisor can prioritize the input received from the control management system to first alter the transmittance and then alter the pattern thus supplying varying voltages to different portions of the one or more non-light emitting, variable transmission devices.

The control management system 110 can regulate the power before sending at most 24V of power to each of the one or more non-light emitting, variable transmission devices. In one embodiment, at most 12V of power can be sent to each of the one or more non-light emitting, variable transmission devices, such as at most 10V, at most 5V, or at most 3V. The system 100 can be used to regulate the transmission of an IGU installed as part of architectural glass along a wall of a building or a skylight, or within a vehicle. As the number of EC devices for a controlled space increases, the complexity in controlling the EC devices can also increase. Even further complexity can occur when the control of the EC devices is integrated with other building environmental controls. In an embodiment, the window can be skylight that may include over 900 EC devices.

The control management system 110 can be mounted on a wall of a building or a skylight and can include all of the wiring. During installation and commissioning, in order to protect both the hardware and software of the control management system 110 from dust or debris, a dust cap can be placed over the control management system 110. The cap can protect the control management system from physical contact by dust and other air particulates, as well as from touching by humans. The cap can include a pouch made from pliable material with an opening, and an elastic material around the opening. The cap can expand to fit around the casing of the control management system 110 and then contract to encompass at least 95% of the control management system 110. The cover can provide a physical protective barrier from dust and debris during construction of a building or installation of the one or more non-light emitting, variable transmission devices. The cover can then be removed after installation and discarded. In one embodiment, the cover is a disposable cover.

The method 200 can include switching the one or more non-light emitting, variable transmission devices all at once or individually at separate times. The one or more non-light emitting, variable transmission devices can be switched to one of eight graded states and one of four tint levels. The four tint levels can be selected from the group consisting of full tint, medium tint, light tint, and full clear. The graded states can be selected from the group consisting of uniform full tint, uniform full clear, uniform light tint, uniform medium tint, full gradient (from top to bottom), inverse full gradient (from bottom to top), light gradient, and inverse light gradient. In one embodiment full clear can be at least 80% transmittance, such as at least 90% transmittance, such as at least 95% transmittance, such as 99% transmittance. In one embodiment, full tint can be no more than 15% transmittance, such as no more than 12% transmittance, no more than 8% transmittance, no more than 6% transmittance, or no more than 3% transmittance. In one embodiment, full tint has less transmittance than medium tint. In another embodiment, medium tint has less transmittance than light tint. In one embodiment, full gradient can have about 95% transmittance in about the first ⅓^{rd} of the device, about 45% transmittance in the second ⅓^{rd} of the device, and about 6% transmittance in the third ⅓^{rd} of the device. In one embodiment, the one or more non-light emitting, variable transmission devices switch from full clear to full tint. In another embodiment, the one or more non-light emitting, variable transmission devices switch from full tint to full clear. In another embodiment, the one or more non-light emitting, variable transmission devices switch from full clear to graded tint or transmission. In another embodiment, the one or more non-light emitting, variable transmission devices can switch from a first pattern to a second pattern.

After reading this specification, skilled artisans will understand that the order of actions in FIG. 2 may be changed. Furthermore, one or more actions may not be performed, and one or more further actions may be performed in generating the collection of scenes.

FIG. 3A an illustration of a top view of a substrate 310, a stack of layers of an electrochromic device 322, 324, 326, 328, and 330, and bus bars 344, 348, 350, and 352 overlying the substrate 300, according to one embodiment. In an embodiment, the substrate 310 can include a glass substrate, a sapphire substrate, an aluminum oxynitride substrate, or a spinel substrate. In another embodiment, the substrate 310 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 310 may or may not be flexible. In a particular embodiment, the substrate 310 can be float glass or a borosilicate glass and have a thickness in a range of 0.5 mm to 4 mm thick. In another particular embodiment, the substrate 310 can include ultra-thin glass that is a mineral glass having a thickness in a range of 50 microns to 300 microns. In a particular embodiment, the substrate 310 may be used for many different non-light-emitting variable transmission devices being formed and may referred to as a motherboard.

The bus bar 344 lies along a side 302 of the substrate 310 and the bus bar 348 lies along a side 304 that is opposite the side 302. The bus bar 350 lies along side 306 of the substrate 310, and the bus bar 352 lies along side 308 that is opposite side 306. Each of the bus bars 344, 348, 350, and 352 has lengths that extend a majority of the distance each side of the substrate. In a particular embodiment, each of the bus bars 344, 348, 350, and 352 have a length that is at least 75%, at least 90%, or at least 95% of the distance between the sides 302, 304, 306, and 308 respectively. The lengths of the bus bars 344 and 348 are substantially parallel to each other. As used herein, substantially parallel is intended to means that the lengths of the bus bars 344 and 348, 350 and 352 are within 10 degrees of being parallel to each other. Along the length, each of the bus bars has a substantially uniform cross-sectional area and composition. Thus, in such an embodiment, the bus bars 344, 348, 350, and 352 have a substantially constant resistance per unit length along their respective lengths.

In one embodiment, the bus bar 344 can be connected to a first voltage supply terminal 360, the bus bar 348 can be connected to a second voltage supply terminal 362, the bus bar 350 can be connected to a third voltage supply terminal 363, and the bus bar 352 can be connected to a fourth voltage supply terminal 364. In one embodiment, the voltage supply terminals can be connected to each bus bar 344, 348, 350, and 352 about the center of each bus bar. In one embodiment, each bus bar 344, 348, 350, and 352 can have one voltage supply terminal. The ability to control each voltage supply terminal 360, 362, 363, and 364 provide for control over grading of light transmission through the electrochromic device 124.

In one embodiment, the first voltage supply terminal 360 can set the voltage for the bus bar 344 at a value less than the voltage set by the voltage supply terminal 363 for the bus bar 350. In another embodiment, the voltage supply terminal 363 can set the voltage for the bus bar 350 at a value greater than the voltage set by the voltage supply terminal 364 for the bus bar 352. In another embodiment, the voltage supply terminal 363 can set the voltage for the bus bar 350 at a value less than the voltage set by the voltage supply terminal 364 for the fourth bus bar 352. In another embodiment, the voltage supply terminal 360 can set the voltage for the bus bar 344 at a value about equal to the voltage set by the voltage supply terminal 362 for the bus bar 348. In one embodiment, the voltage supply terminal 360 can set the voltage for the bus bar 344 at a value within about 0.5V, such as 0.4V, such as 0.3V, such as 0.2V, such as 0.1V to the voltage set by the voltage supply terminal 362 for the second bus bar 348. In a non-limiting example, the first voltage supply terminal 360 can set the voltage for the bus bar 344 at 0V, the second voltage supply terminal 362 can set the voltage for the bus bar 348 at 0V, the third voltage supply terminal 363 can set the voltage for the bus bar 350 at 3V, and the fourth voltage supply terminal 364 can set the voltage for the bus bar 352 at 1.5V.

The compositions and thicknesses of the layers are described with respect to FIGS. 3B and 3C. Transparent conductive layers 322 and 330 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 322 and 330 can include gold, silver, copper, nickel, aluminum, or any combination thereof. The transparent conductive layers 322 and 330 can have the same or different compositions.

The set of layers further includes an electrochromic stack that includes the layers 324, 326, and 328 that are disposed between the transparent conductive layers 322 and 330. The layers 324 and 328 are electrode layers, wherein one of the layers is an electrochromic layer, and the other of the layers is an ion storage layer (also referred to as a counter electrode layer). The electrochromic layer can include an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, or any combination thereof and have a thickness in a range of 50 nm to 2000 nm. The ion storage layer can include any of the materials listed with respect to the electrochromic layer or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 80 nm to 500 nm. An ion conductive layer 326 (also referred to as an electrolyte layer) is disposed between the electrode layers 324 and 328, and has a thickness in a range of 20 microns to 60 microns. The ion conductive layer 326 allows ions to migrate there through and does not allow a significant number of electrons to pass there through. The ion conductive layer 326 can include a silicate with or without lithium, aluminum, zirconium, phosphorus, boron; a borate with or without lithium; a tantalum oxide with or without lithium; a lanthanide-based material with or without lithium; another lithium-based ceramic material; or the like. The ion conductive layer 326 is optional and, when present, may be formed by deposition or, after depositing the other layers, reacting portions of two different layers, such as the electrode layers 324 and 328, to form the ion conductive layer 326. After reading this specification, skilled artisans will appreciate that other compositions and thicknesses for the layers 322, 324, 326, 328, and 330 can be used without departing from the scope of the concepts described herein.

The layers 322, 324, 326, 328, and 330 can be formed over the substrate 210 with or without any intervening patterning steps, breaking vacuum, or exposing an intermediate layer to air before all the layers are formed. In an embodiment, the layers 322, 324, 326, 328, and 330 can be serially deposited. The layers 322, 324, 326, 328, and 330 may be formed using physical vapor deposition or chemical vapor deposition. In a particular embodiment, the layers 322, 324, 326, 328, and 330 are sputter deposited.

In the embodiment illustrated in FIG. 3B and 3C, each of the transparent conductive layers 322 and 330 include portions removed, so that the bus bars 344/348 and 350/352 are not electrically connected to each other. Such removed portions are typically 20 nm to 2000 nm wide. In a particular embodiment, the bus bars 344 and 348 are electrically connected to the electrode layer 324 via the transparent conductive layer 322, and the bus bars 350 and 352 are electrically connected to the electrode layer 328 via the transparent conductive layer 330. The bus bars 344, 348, 350, and 352 include a conductive material. In an embodiment, each of the bus bars 344, 348, 350, and 352 can be formed using a conductive ink, such as a silver frit, that is printed over the transparent conductive layer 322. In another embodiment, one or both of the bus bars 344, 348, 350, and 352 can include a metal-filled polymer. In a particular embodiment (not illustrated), the bus bars 350 and 352 are each a non-penetrating bus bar that can include the metal-filled polymer that is over the transparent conductive layer 330 and spaced apart from the layers 322, 324, 326, and 328. The viscosity of the precursor for the metal-filled polymer may be sufficiently high enough to keep the precursor from flowing through cracks or other microscopic defects in the underlying layers that might be otherwise problematic for the conductive ink. The lower transparent conductive layer 322 does not need to be patterned in this particular embodiment. In one embodiment, bus bars 344 and 348 are opposed each other. In one embodiment, bus bars 350 and 352 are orthogonal to bus bar 344.

In the embodiment illustrated, the width of the non-light-emitting variable transmission device W_{EC} is a dimension that corresponds to the lateral distance between the removed portions of the transparent conductive layers 322 and 330. W_{S} is the width of the stack between the bus bars 344 and 348. The difference in W_{S} and W_{EC} is at most 5 cm, at most 2 cm, or at most 0.9 cm. Thus, most of the width of the stack corresponds to the operational part of the non-light-emitting variable transmission device that allows for different transmission states. In an embodiment, such operational part is the main body of the non-light-emitting variable transmission device and can occupy at least 90%, at least 95%, at least 98% or more of the area between the bus bars 344 and 348.

Attention is now addressed to installing, configuring, and using the system as illustrated in FIG. 1 with glazings and non-light-emitting, variable transmission devices that can be similar to the glazing and non-light-emitting, variable transmission device as illustrated and described with respect to FIGS. 3A-3C. In another embodiment, other designs of glazings and non-light-emitting, variable transmission devices.

Embodiments as described above can provide benefits over other systems with non-light-emitting, variable transmission devices. The use of controllers to regulate the power supply to the non-light emitting, variable transmission devices maintains the safety of the system, utilizes the full capacity of the power supply, and maintains a class 2 circuit for the system thereby reducing the cost to the end consumer.

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

Embodiment 1. A control system can include one or more non-light emitting, variable transmission devices and a control management device, where the control management device includes a touch-panel platform and a logic element configured to map one or more operational parameters of the one or more non-light emitting, variable transmission devices, integrate the mapped one or more operational parameters into the touch panel platform, and send one or more signals to the one or more non-light emitting, variable transmission devices in response to input received from the touch panel control platform.

Embodiment 2. A computer-readable medium including contents that are configured to cause a computing system to sort data by performing a method including mapping one or more operational parameters of one or more non-light emitting, variable transmission devices, integrating the mapped one or more operational parameters into a touch panel platform, and sending one or more signals to the one or more non-light emitting, variable transmission devices in response to input received from the touch panel control platform.

Embodiment 3. A method of controlling a non-light emitting, variable transmission device, can include mapping one or more operational parameters of the one or more non-light emitting, variable transmission devices, integrating the mapped one or more operational parameters into a touch panel platform, and sending one or more signals to the one or more non-light emitting, variable transmission devices in response to input received from the touch panel control platform.

Embodiment 4. The method, system, or medium of any one of embodiments 1 to 3, where the one or more non-light emitting, variable transmission devices is an electrochromic device.

Embodiment 5. The method, system, or medium of any one of embodiments 1 to 3, can further include switching the one or more non-light emitting variable transmission devices from a first state to a second state.

Embodiment 6. The method, system, or medium of any one of embodiments 1 to 3, can further include changing the transmittance of the one or more non-light emitting, variable transmission devices after receiving the one or more signals.

Embodiment 7. The method, system, or medium of any one of embodiments 1 to 3, where the touch panel platform comprises one or more modules.

Embodiment 8. The method, system, or medium of any one of embodiments 1 to 3, where the mapped operational parameters include algorithms selected from the group consisting of 3-D models of a building and surrounding structures, pre-programmed scenes, shadow information, reflectance information, lighting and radiation information, information regarding one or more variable characteristics of glass, log information related to manual overrides, occupant preference information, motion information, real-time sky conditions, solar radiation on a building, brightness, time-of-year information, commissioning information such as dimensions of each non-light emitting, variable transmission device, and microclimate analysis.

Embodiment 9. The method, system, or medium of any one of embodiments 1 to 3, can further include prioritizing the operational parameters.

Embodiment 10. The method, system, or medium of any one of embodiments 1 to 3, where the logic element sends one or more signals to a supervisor, the supervisor prioritizes the operational parameters, and then the supervisor sends a command to the one or more non-light emitting, variable transmission devices in response to input received from the touch panel control platform.

Embodiment 11. The method, system, or medium of any one of embodiments 1 to 3, can further include sending a second set of one or more signals to the one or more non-light emitting, variable transmission devices in response to input received from the touch panel control platform, after the first set of one or more signals.

Embodiment 12. The method, system, or medium of any one of embodiments 1 to 3, wherein the one or more non-light emitting, variable transmission devices can include a substrate, a first transparent conductive layer, a second transparent conductive layer, an electrochromic layer disposed between the first transparent conductive layer and the second transparent conductive layer, and a counter electrode layer disposed between the first transparent conductive layer and the second transparent conductive layer.

Embodiment 13. The method, system, or medium of embodiment 12, wherein the substrate is a material selected from the group consisting of a glass, sapphire, aluminum oxynitride, spinel, polyalkene, polycarbonate, polyester, polyether, polyethylene, polyimide, polysulfone, polysulfide, polyurethane, polyvinylacetate, another suitable transparent polymer, or a co-polymer of the foregoing, borosilicate glass, and any combination thereof.

Embodiment 14. The method, system, or medium of embodiment 12, wherein the first transparent conductive layer is a material selected from the group consisting of a tin oxide, zinc oxide doped with a trivalent element, such as Al, Ga, In, a fluorinated tin oxide, a sulfonated polymer, polyaniline, polypyrrole, poly(3,4-ethylenedioxythiophene), and can include gold, silver, copper, nickel, aluminum, or any combination thereof.

Embodiment 15. The method, system, or medium of embodiment 12, where the second transparent conductive layer is a material selected from the group consisting of a tin oxide, zinc oxide doped with a trivalent element, such as Al, Ga, In, a fluorinated tin oxide, a sulfonated polymer, polyaniline, polypyrrole, poly(3,4-ethylenedioxythiophene), and can include gold, silver, copper, nickel, aluminum, and any combination thereof.

Embodiment 16. The method, system, or medium of embodiment 12, where the electrochromic layer is a material selected from the group consisting of WO₃, V₂O₅, MoO₃, Nb₂O₅, TiO₂, CuO, Ir₂O₃, Cr₂O₃, CO₂O₃, Mn₂O₃, and any combination thereof.

Embodiment 17. The method, system, or medium of embodiment 12, where the counter electrode layer is a material selected from the group consisting of Ta₂O₅, ZrO₂, HfO₂, Sb₂O₃, nickel oxide (NiO, Ni₂O₃, or combination of the two), and doped with Li, Na, and H, and any combination thereof.

Embodiment 18. The method, system, or medium of embodiment 5, where the first state is full clear and the second state is full tint.

Embodiment 19. The method, system, or medium of embodiment 5, where the first state is full tint and the second state is full clear.

Embodiment 20. The method, system, or medium of embodiment 5, where the first state is full clear and the second state is graded tint.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A control system, comprising:
one or more non-light emitting, variable transmission devices; and
a control management device, wherein the control management device comprises a touch-panel platform and a logic element configured to:
map one or more operational parameters of the one or more non-light emitting, variable transmission devices;
integrate the mapped one or more operational parameters into the touch panel platform; and
send one or more signals to the one or more non-light emitting, variable transmission devices in response to input received from the touch panel control platform.

2. The system of claim 1, wherein the one or more non-light emitting, variable transmission devices is an electrochromic device.

3. The system of claim 1, wherein the touch panel platform comprises one or more modules.

4. The system of claim 1, wherein mapping the one or more operational parameters include parameters selected from the group consisting of 3-D models of a building and surrounding structures, pre-programmed scenes, shadow information, reflectance information, lighting and radiation information, information regarding one or more variable characteristics of glass, log information related to manual overrides, occupant preference information, motion information, real-time sky conditions, solar radiation on a building, brightness, time-of-year information, commissioning information such as dimensions of each non-light emitting, variable transmission device, and microclimate analysis.

5. The system of claim 1, further comprising prioritizing the one or more operational parameters.

6. The system of claim 1, wherein the one or more non-light emitting, variable transmission devices comprises:
a substrate;
a first transparent conductive layer;
a second transparent conductive layer;
an electrochromic layer disposed between the first transparent conductive layer and the second transparent conductive layer; and
a counter electrode layer disposed between the first transparent conductive layer and the second transparent conductive layer.

7. The system of claim 6, wherein the substrate is a material selected from the group consisting of a glass, sapphire, aluminum oxynitride, spinel, polyalkene, polycarbonate, polyester, polyether, polyethylene, polyimide, polysulfone, polysulfide, polyurethane, polyvinylacetate, another suitable transparent polymer, or a co-polymer of the foregoing, borosilicate glass, and any combination thereof.

8. The system of claim 6, wherein the first transparent conductive layer is a material selected from the group consisting of a tin oxide, zinc oxide doped with a trivalent element, such as Al, Ga, In, a fluorinated tin oxide, a sulfonated polymer, polyaniline, polypyrrole, poly(3,4-ethylenedioxythiophene), and can include gold, silver, copper, nickel, aluminum, or any combination thereof.

9. The system of claim 6, wherein the second transparent conductive layer is a material selected from the group consisting of a tin oxide, zinc oxide doped with a trivalent element, such as Al, Ga, In, a fluorinated tin oxide, a sulfonated polymer, polyaniline, polypyrrole, poly(3,4-ethylenedioxythiophene), and can include gold, silver, copper, nickel, aluminum, and any combination thereof.

10. The system of claim 6, wherein the electrochromic layer is a material selected from the group consisting of WO₃, V₂O₅, MoO₃, Nb₂O₅, TiO₂, CuO, Ir₂O₃, Cr₂O₃, Co₂O₃, Mn₂O₃, and any combination thereof.

11. The system of claim 6, wherein the counter electrode layer is a material selected from the group consisting of Ta₂O₅, ZrO₂, HfO₂, Sb₂O₃, nickel oxide (NiO, Ni₂O₃, or combination of the two), and doped with Li, Na, and H, and any combination thereof.

12. A method of controlling a non-light emitting, variable transmission device, comprising:
mapping one or more operational parameters of the one or more non-light emitting, variable transmission devices;
integrating the mapped one or more operational parameters into a touch panel platform; and
sending one or more signals to the one or more non-light emitting, variable transmission devices in response to input received from the touch panel control platform.

13. The method of claim 12, further comprising switching the one or more non-light emitting variable transmission devices from a first state to a second state.

14. The method, system, or medium of claim 13, wherein the first state is full clear and the second state is full tint.

15. The method, system, or medium of claim 13, wherein the first state is full tint and the second state is full clear.

16. The method, system, or medium of claim 13, wherein the first state is full clear and the second state is graded tint.

17. The method of claim 12, further comprising changing the transmittance of the one or more non-light emitting, variable transmission devices after receiving the one or more signals.

18. The method of claim 12, wherein the logic element sends one or more signals to a supervisor, the supervisor prioritizes the one or more operational parameters, and then the supervisor sends a command to the one or more non-light emitting, variable transmission devices in response to input received from the touch panel control platform.

19. The method of claim 12, further comprising sending a second set of one or more signals to the one or more non-light emitting, variable transmission devices in response to input received from the touch panel control platform, after the first set of one or more signals.

20. A computer-readable medium including contents that are configured to cause a computing system to sort data by performing a method comprising:
mapping one or more operational parameters of one or more non-light emitting, variable transmission devices;
integrating the mapped one or more operational parameters into a touch panel platform; and
sending one or more signals to the one or more non-light emitting, variable transmission devices in response to input received from the touch panel control platform.
